(19) United States
(12) Patent Application Publication
(10) Pub. No.: US 2026/0137191 A1
(43) Pub. Date: May 21, 2026

(54) ROBOTIC ARM OF A NAIL POLISH APPLICATION APPARATUS

(71) Applicant: Nailomatic Ltd., Tel-Aviv (IL)

(72) Inventors: Avichay MOR YOSEF, Jerusalem (IL); Omri MORAN, New York, NY (US); Ron MILLER, Herzlia (IL); Boris KHODOS, Beer Yaakov (IL)

(73) Assignee: Nailomatic Ltd., Tel-Aviv (IL)

(21) Appl. No.: 18/706,007

(22) PCT Filed: Nov. 8, 2022
(86) PCT No.: PCT/IL2022/051182

§ 371 Date: Apr. 30, 2024

Related U.S. Application Data
(60) Provisional application No. 63/276,674, filed on Nov. 8, 2021.

(51) Int. Cl. A45D 29/00; A45D 34/04; B25J 9/06

(52) U.S. Cl. CPC A45D 29/00; A45D 34/045; B25J 9/06

(57) ABSTRACT

Disclosed herein is a robotic arm system comprising one or more actuators adapted to actuate a plurality of joints connecting between a shoulder base and a first arm section and between the first arm section and a second arm section having a first anchor connector and connected to an end effector, an upper mount connected to the shoulder base for fixating a second anchor connector above a plane on which the robotic arm is mounted, and a control unit adapted to induce lifting the end effector in relation to the plane by instructing the one or more actuators for inducing movement of the second arm section with respect to the upper mount in an axis parallel to the plane to mechanically and detachably connect between the first and second anchor connectors in an axis perpendicular to the plane, and then lifting the upper mount perpendicularly to the plane.

### RELATED APPLICATIONS

This application claims the benefit of priority of U.S. Provisional Patent Application No. 63/276,674 filed on 8 Nov. 2021, the contents of which are incorporated herein by reference in their entirety.

### FIELD AND BACKGROUND OF THE INVENTION

The present invention, in some embodiments thereof, relates to a robotic arm and, more particularly, but not exclusively, to robotic arm of an automated nail polish application apparatus constructed of accurately maneuverable arm segments configured to detachably lock to a rigid upper mount for operations requiring increased force.

Applying nail polish to fingernails and/or toenails has been practiced since ancient times. Decorating the finger and/or toe nails is still fashionable in modern times as many people, in particular woman apply nail polish to decorate their fingernails and/or toenails.

Traditionally, manual nail polish application is the most common method. The manual nail polish application may require some expertise, skills and/or experience and may be time consuming. In addition, manual application of the nail polish to one self's nails may be physically challenging due to the need to master the art in both hands and in case of the foot toenails reaching conveniently and efficiently the toes may also present difficulties. While many individuals have mastered the art of applying the nail polish manually for themselves, nail polish application may typically be practiced by professional manicurists and/or pedicurists.

With the advancement of technology and an enabling technical environment, automated nail polish application is becoming more common and popular and automated nail polish application apparatuses are used by more and more users for efficiently applying nail polish.

### SUMMARY OF THE INVENTION

According to a first aspect of the present invention there is provided a robotic arm system mounted on a plane, comprising one or more actuators adapted to actuate a plurality of joints connecting between a shoulder base and a first arm section and between the first arm section and a second arm section having a first anchor connector and connected to an end effector, and an upper mount connected to the shoulder base for fixating a second anchor connector above the plane; and a control unit adapted to induce lifting the end effector in relation to the plane by instructing the one or more actuators for: inducing movement of the second arm section with respect to the upper mount in an axis parallel to the plane to mechanically and detachably connect between the first and second anchor connectors in an axis perpendicular to the plane, and then lifting the upper mount perpendicularly to the plane.

According to a second aspect of the present invention there is provided a method for operating a robotic arm mounted on a plane, comprising using a control unit of a robotic arm adapted to induce lifting of an end effector of the robotic arm with respect to the plane by: instructing one or more actuators of the robotic arm to actuate a plurality of joints connecting between a shoulder base of the robotic arm and a first arm section of the robotic arm and between the first arm section and a second arm section of the robotic arm having a first anchor connector and connected to the end effector for: inducing movement of the second arm section with respect to the upper mount in an axis parallel to the plane to mechanically and detachably connect, in an axis perpendicular to the plane, between the first anchor connector and a second anchor connector of the robotic arm fixated by an upper mount connected to the shoulder base, and then lifting the upper mount perpendicularly to the plane.

In a further implementation form of the first and second aspects, the second anchor connector comprises a notch configured to receive and accommodate a T shaped element of the first anchor connector.

In a further implementation form of the first and second aspects, the second anchor connector comprises a notch configured to receive and accommodate a ball shaped element of the first anchor connector.

In a further implementation form of the control unit is adapted to instruct the one or more actuators to induce movement of the second arm section in a longitudinal axis parallel to the plane to mechanically and detachably connect between the first and second anchor connectors.

In a further implementation form of the first and second aspects, the control unit is adapted to instruct the one or more actuators to induce movement of the second arm section in a lateral axis parallel to the plane to mechanically and detachably connect between the first and second anchor connectors.

In a further implementation form of the first and second aspects, the control unit is adapted to instruct the one or more actuators to induce movement of the second arm section in rotation around a longitudinal axis parallel to the plane to mechanically and detachably connect between the first and second anchor connectors.

In a further implementation form of the first and second aspects, the control unit is adapted to instruct the one or more actuators to induce movement of the second arm section while the first anchor connector is connected to the second anchor connector to maneuver the end effector to grasp a non-screw detachable cover of a nail polish capsule comprising an integrated nail polish applying element and insert and/or extract the integrated nail polish applying element in and/or out of a body portion of the nail polish capsule.

In a further implementation form of the first and second aspects, the control unit is further adapted to instruct the one or more actuators to induce movement of the second arm section such that the nail polish applying element rotates in one or more axes with respect to the plane around a tip of a dispensing head of the nail polish applying element.

In a further implementation form of the first and second aspects, the control unit is adapted to instruct the one or more actuators to induce movement of the second arm section in a longitudinal axis, a lateral axis, and a perpendicular axis with respect to the plane while the first anchor connector is disconnected from the second anchor connector to maneuver the end effector grasping the non-screw detachable cover in order to move the integrated nail polish applying element for applying nail polish fluid on one or more nail surfaces of a user.

In a further implementation form of the first and second aspects, the control unit is further adapted to instruct the one or more actuators to induce rotation of the second arm section around the longitudinal axis.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a perspective view of an exemplary robotic arm of a nail polish application apparatus, according to some embodiments of the present invention;

FIG. 2 presents front views of an exemplary robotic arm of a nail polish application apparatus in several rotation states of its end effector, according to some embodiments of the present invention;

FIG. 3 presents perspective views of exemplary anchor connectors of a robotic arm of a nail polish application apparatus in several anchoring states, according to some embodiments of the present invention;

FIG. 4 presents perspective views of an exemplary robotic arm of a nail polish application apparatus in several anchoring states, according to some embodiments of the present invention;

FIG. 5 presents side views of an exemplary robotic arm of a nail polish application apparatus in several anchoring states, according to some embodiments of the present invention; and

FIG. 6 is a flowchart of an exemplary process for operating robotic arm of a nail polish application apparatus to apply, on one or more nail surfaces, nail polish initially contained in a two-part nail polish capsule, according to some embodiments of the present invention.

### DETAILED DESCRIPTION OF EMBODIMENTS OF THE INVENTION

The present invention, in some embodiments thereof, relates to a robotic arm and, more particularly, but not exclusively, to robotic arm of an automated nail polish application apparatus constructed of accurately maneuverable arm segments configured to detachably lock to a rigid upper mount for operations requiring increased force.

According to some embodiments of the present invention there is provided a robotic arm of an automated nail polish application apparatus comprising an end effector configured to grasp, i.e. receive and hold a nail polish applying element, for example, a brush, a sponge and/or the like. The robotic arm may be then operated and moved to maneuver end effector grasping the nail polish applying element to apply nail polish fluid, for example, a polish fluid, a base coating fluid, a top coating fluid, a drying material, a nail art polish fluid, a medical nail treatment fluid and/or the like on one or more nail surfaces of fingers and/or toes of a user.

The primary operation mode of the robotic arm may be therefore to maneuver the nail polish applying element in order to apply the nail polish fluid on the nail surfaces. Such nail applying operation may require fine, accurate, delicate and/or flexible movement of the nail polish applying element in a plurality of directions and axes with respect to the plane of the robotic arm in order to accurately apply the nail polish fluid on the entire nail surfaces within their borders and without digressing (moving out) to the surrounding skin. Moreover, accurately, delicately and/or flexibly moving the nail polish applying element during the nail polish application may be required to apply a precise pressure of the nail polish applying element, specifically of a dispensing head of the nail polish applying element to apply an accurate amount of nail polish on the nail surfaces.

However, while the robotic arm may be primarily operated and moved to induce highly accurate, delicate and fine movement of the end effector grasping the nail polish applying element requiring limited, significantly low force, the robotic arm may be involved in some relatively high force operations, in which the end effector may be moved with significantly high force to overcome substantial mechanical resistance.

For example, the nail polish application apparatus may use one or more two-part nail polish capsules containing the nail polish fluid and typically inserted and/or located in one or more dedicated compartment and/or chambers of the nail polish application apparatus. Each two-part nail polish capsule may be constructed of a body portion containing the nail polish fluid and a non-screw detachable cover integrating the nail polish applying element which is attached to close and seal the body portion using one or more non-screw techniques, for example, press-fit, clamping, clasping, fastening, gluing and/or the like.

In such case, the robotic arm may be operated to apply one or more high force operations, specially to induce high force movement of the end effector, for example, to detach the detachable cover form the body portion, to attach the detachable cover to the body portion, to insert the nail polish applying element into the body portion to collect nail polish fluid and/or the like. The high force operations relating to the nail polish application apparatus as designated herein refer to operations which require significant force to overcome the detachment (and attachment) force between the non-screw detachable cover and the body portion of the nail polish capsule, for example, in a range of 5-15 N (Newton).

The robotic arm of the nail polish application apparatus may be therefore constructed to support both high accuracy, fine and flexible movement of the end effector as well as high force movement of the end effector which may typically require lower precision.

The robotic arm may comprise of a plurality of arm segments connected to a shoulder base, to each other and to the end effector via a plurality of joints to support flexible and accurate movement of the end effector in a plurality of axes with respect to the mounting plane, for example, longitudinally, laterally, perpendicularly and in rotation around the longitudinal axis with respect to the plane. For example, the robotic arm may comprise two arm sections, a first arm section and a second arm section where the first arm section is connected via joints to the shoulder base and the to the second arm section which is connected to the end effector optionally through another joint.

The robotic arm may include one or more first actuators which may be operated and instructed by one or more controllers of the nail polish application apparatus to induce accurate movement of the arm sections, in particular of the second arm section in order to move and maneuver the end effector connected to the second arm section for applying the nail polish fluid on the nail surface(s). As stated before, this accurate, fine, and/or delicate movement of the arm sections which involves maneuvering the end effector grasping the low weight nail polish applying element may require very limited and typically significantly low force.

However, the multi-joint robotic arm comprising a plurality of arm sections may be significantly agile, light weight and thus not very robust which may limit its ability to carry out the high force operations and/or effectively endure the mechanical stress induced by theses high force operations.

The robotic arm may therefore include an upper mount which may be moveable in one or more directions and/or axes with respect to the mounting plane, for example, laterally and/or perpendicularly to the plane while rigidly connected and fixated to the shoulder base of the robotic arm. In particular, one or more second actuator(s) may be operated and instructed by the controller(s) to induce movement of the upper mount.

In order to support the accurate low force movement of the arm section on one hand and the high force relatively low-accuracy movement of the arm sections, the robotic arm may be configured and operated to induce movement of the second arm section and hence movement of the end effector in two main operations modes, a connected mode and a disconnected mode. In the disconnected mode, the arm sections, specifically the second arm section to which the end effector is connected, may be moved separately and independently (free) of the upper mount while in the connected mode, the arm sections, specifically the second arm section may be moved while connected and locked (anchored) to the upper mount.

To this end, one or more of the arm sections, for example, the second arm section may include a first anchor connector configured to detachably connect to a second anchor connector disposed on the upper mount. One or more methods, techniques and/or constructions may be applied for designing, shaping and/or configuring the first anchor connector and the second anchor connector to detachably connect to each other. For example, the first anchor connector disposed on the second arm section may comprise a T shaped element, a ball element and/or the like while the second anchor connector disposed on the upper mount may comprise a notch configured to receive and accommodate the T shaped element and/or the ball element of the first anchor connector.

In the first operation mode, while the arm sections are disconnected from the upper mount, the controller(s) may instruct the first actuator(s), to induce high accuracy, fine and/or subtle movement of the second arm section longitudinally, laterally, perpendicularly and/or rotationally to the mounting plane in order to accurately and flexibly maneuver the end effector grasping the nail polish applying element to apply the nail polish fluid on the nail surfaces of the user.

In the second operation mode, while the arm sections are connected to the upper mount, the controller(s) may instruct the second actuator(s), in particular which may be relatively high force actuator(s) to induce high force movement of the second arm section perpendicularly and optionally longitudinally and/or laterally to the mounting plane in order to support high force movement of the upper mount and hence of the end effector connected to the second arm section which is connected to the upper mount. In particular, the high force second actuator(s) may be instructed to induce high force movement of the upper mount to lift the second arm section in the axis perpendicular to the plane in order to execute one or more of the high force operations relating to the body portion located in the capsule compartment beneath the robotic arm, for example, detach the detachable cover form the body portion, attach the detachable cover to the body portion, insert the nail polish applying element into the body portion and/or the like.

The controller(s) may further instruct one or more of the first actuator(s) to induce movement of the second arm section with respect to the upper mount to connect and/or disconnect the first anchor connector to and/or from the second anchor connector in order to connect and disconnect the second arm section to and/or from the upper mount.

The robotic arm operable in two operations modes, namely the connected mode and the disconnected mode may present major benefits and advantages over currently existing robotic arms.

First, the existing robotic arms may typically include arm sections configured to move freely and independently which may be equivalent to the disconnected mode. The arm sections of the existing robotic arms therefore need to be highly rigid and robust in order support the relatively high force operations and sustain the induced mechanical stress. The arm sections of the existing robotic arms may be therefore built of strong, rigid and/or highly durable materials which may significantly increase the cost of the robotic arm. Moreover, since the joints of the existing robotic arms also need to endure the high mechanical stress during the high force operations, these joints may be high end joints constructed of robust materials which may further increase the costs of the existing robotic arms. Furthermore, the robust arm sections may be relatively heavy which may inflict additional mechanical stress on the joints which should be therefore further enforced.

In contrast, since the robotic arm of the present invention is configured to conduct the high force operations in the connected mode while connected to the rigid upper mount configured to absorb and sustain the mechanical stress induced during the high force movement, the arm sections are never subject to the high mechanical stress induced by the high force movement. The arm sections of two operation mode robotic arm may be therefore significantly light weight, agile and less robust compared to the existing robotic arms and may be producible of low cost materials which may significantly reduce the cost of the robotic arm. Moreover, since the arm sections are not subject to high mechanical stress they may experience reduced failure rate and/or require reduced maintenance.

Moreover, since the multiple joints connecting the arm sections of the two operation mode robotic arm are also never subject to the high mechanical stress induced during the high force movement and further since the arm sections are light weight, the joints may be built using significantly lower cost materials and/or employ reduced complexity construction which may further reduce the cost, failure rate and/or maintenance of the robotic arm.

The upper mount of the two mode robotic arm which is the element which needs to sustain the high mechanical stress developed during the high force movement is a mostly fixed and rigid structure having no joints. The upper mount may be therefore enforced to support high rigidity and robustness through an enforced construction design capable of enduring the high mechanical stress while using light weight low cost materials thus not significantly increasing the cost of the robotic arm.

Furthermore, the multi-joint construction of the robotic arm to connect the plurality of arm sections may enable very accurate, flexible, delicate and/or subtle movement of the arm sections in the disconnected mode which may allow using relatively lower precision first actuator(s) which may be significantly simple and/or lower cost thus reducing the cost of the robotic arm compared to the existing robotic arms requiring high precision actuators. Such low cost actuators may also be significantly simpler, require less maintenance and/or susceptible to fails compared to the high end actuators of the existing robotic arms.

In addition, configuring the robotic arm to operate in the two operations modes may allow the use of two distinct types of low-end actuators. Specifically, the first actuator(s) which may be operated, in the disconnected mode, to induce the high-precision, accurate, fine, subtle and flexible movement of the end effector which may require low force and the second actuator(s) characterized by high force and typically low-precision to induce high force and less accurate movement of the end effector in the connected mode. Such low-end actuators may be significantly cheaper and/or simpler which may require reduced maintenance and are typically susceptible to less failures compared to the high end actuators of the existing robotic arms each required to simultaneously support both the high precision movement as well as the high force movement of the end effector.

Also, since the robotic arm of the present invention comprises light weight arm sections producible of low cost materials and simple joints compared to the arm segments of the existing robotic arms which are subject to high force movement and are therefore built of stronger, more robust, more rigid and/or more durable materials and high end joints. The low cost arm sections and simple joints may therefore significantly reduce the cost of the robotic arm compared to the existing robotic arms. Moreover, the more robust arm sections of the existing robotic arms may be significantly heavier which may require using stronger and thus higher cost actuators compared to the actuators used to induce movement of the light weight arms section of the robotic arm of the present invention.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

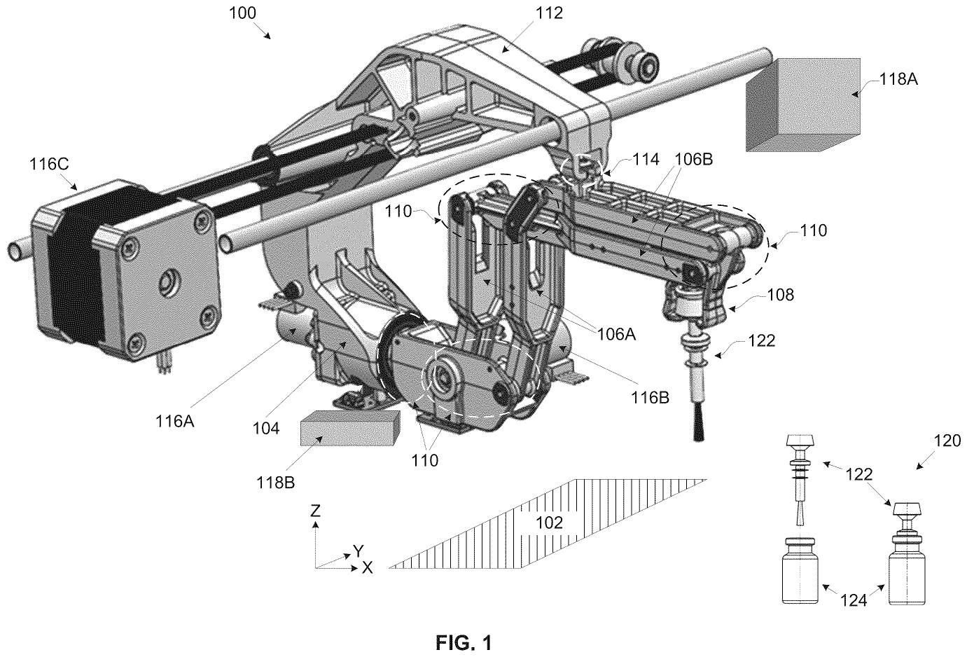

Referring now to the drawings, FIG. 1 is a perspective view of an exemplary robotic arm of a nail polish application apparatus, according to some embodiments of the present invention. An exemplary robotic arm 100 of an automated nail polish application apparatus may be configured and operated to apply nail polish on nail surface(s) of a user, for example, hand finger nails and/or foot toe nails.

The robotic arm 100 mounted on a (reference) plane 102 may include a shoulder base 104, a plurality of arm sections 106, for example, a first arm section 106A and a second arm section 106B and effector 108 connected to the second arm section 106B.

The end effector 108 may be shaped and configured to grasp, i.e. receive and accommodate one or more objects, elements and/or the like. Specifically, the end effector 108 may be shaped and configured to grasp one or more nail polish applying elements, in particular a nail polish applying element integrated with a non-screw detachable cover 122 of a two-part nail polish capsule 120 shown separately.

The two-part nail polish capsule 120 may be constructed of a body portion 124, typically a flask shaped body portion and the detachable cover (cap) 122 attached and/or mechanically coupled to the body portion 124 to seal the opening of the body portion 124. The body portion 124 which may typically include reservoir configured to contain one or more nail polish fluids, for example, a polish fluid, a base coating fluid, a top coating fluid, a drying material, a nail art polish fluid, a medical nail treatment fluid and/or the like and a neck section. The nail polish applying element integrated with the non-screw detachable cover 122 may typically include a stem and a dispensing head which may be dipped in the body portion 124 to collect nail polish fluid and operated to apply the nail polish fluid on one or more of the nail surfaces.

The detachable cover 122 is a non-screw detachable cover which is not screwed to the body portion 124 but is rather mechanically coupled to the body portion 124 through one or more techniques, methods and/or implementations, for example, press-fit, clamping, clasping, fastening, gluing and/or the like. As such the detachable cover 122 integrating the nail polish applying element may be therefore attached and/or detached to the body portion 124 by perpendicularly inserting and/or extracting the detachable cover 122 in and/or out of the body portion 124 with no screw and/or rotation operation(s) of the detachable cover 122 and/or of the body portion 124.

The arm sections 106 of the robotic arm 100, for example, the first arm section 106A and the second arm section 106B connected to the end effector 108 may be connected to the shoulder base 104 and to each other through a plurality of joints 110 configured to provide a plurality of freedom degrees of movement of one or more of the arm sections 106 with respect to the plane 102 and or with respect to each other. One or more of the arm sections 106 may be therefore moved to maneuver the end effector 108 in a plurality of directions and axes with respect to the plane 102.

For example, the robotic arm 100 may be operated and moved to induce lateral movement of the second arm section 106B, specifically of the end effector 108 along the Y axis with respect to the plane 102. In another example, the robotic arm 100 may be operated and moved to induce longitudinal movement of the second arm section 106B, specifically of the end effector 108 along the X axis with respect to the plane 102. In another example, the robotic arm 100 may be operated and moved to induce perpendicular movement of the second arm section 106B along the Z axis with respect to the plane 102 for lifting the end effector 108.

The robotic arm 100 may be further operated and moved to induce rotation (movement) of one or more of the arm sections 106 of the robotic arm 100, for example, rotation of the second arm section 106B and thus rotation of the end effect effector 108 around the longitudinal axis, i.e., around the X axis with respect to the plane 102.

Optionally, the end effector 108 may be connected to the second arm section 106B via one or more joints such as the joints 110 in order to further increase flexibility and maneuverability of the end effector with respect to the plane 102. In such case, the robotic arm 100 may be optionally operable to induce movement of the end effector 108 with respect to the second arm 106B in one or more directions and/or axes, for example, laterally with respect to the plane 102, perpendicularly to then plane 102, in rotation around the longitudinal axis, i.e., around the X axis with respect to the plane 102 and/or the like.

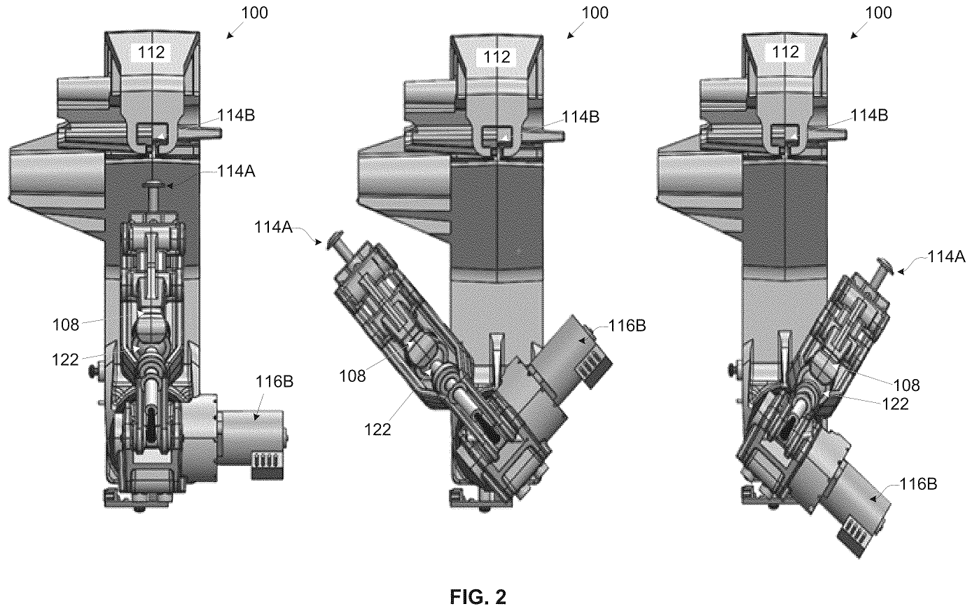

Reference is also made to FIG. 2, which presents front views of an exemplary robotic arm of a nail polish application apparatus in several rotation states of its end effector, according to some embodiments of the present invention. As seen at 202, 204 and 206, the robotic arm 100 may be operated and moved to move one or more of its arm sections 106 to induce rotation of the second arm section 106B around the longitudinal axis, i.e., around the X axis with respect to the plane 102 thus rotating the end effector 108 around the longitudinal axis.

The robotic arm 100 may further include an upper mount 112 which while moveable in one or more axes with respect to the plane 102, for example, perpendicularly, laterally and/or longitudinally, may be rigidly connected and fixated to the shoulder base 104.

The robotic arm 100 may be operated in two primary operation modes, a connected mode and a disconnected mode. In the disconnected mode, the arm sections 106, specifically the second arm section 106B to which the end effector 108 is connected may be moved while disconnected and independent (free) of the upper mount 112. In the connected mode, on the other hand, the arm sections 106 may be moved while anchored and connected (locked) to the upper mount 112 such that moving the upper mount 112 may induce movement of the arm sections 106, specifically of the second arm section 106B to which the end effector 108 is connected.

In particular, in the connected mode, in which the second arm section 106B is anchored and connected to the upper mount 112, when inducing movement of the upper mount 112 in an axis perpendicular to the plane 102, the second arm section 106B may move together with the upper mount 112 perpendicularly to the plane 102 (thus lifting the end effector 108) with only significant low and negligible force, moment and/or torque applied on the second arm section 106B.

The disconnected mode, in which the arm sections 106, specifically the second arm section 106B are disconnected from the upper mount 112, may be applied to induce fine, accurate, delicate and/or flexible movement of the second arm section 106B and the end effector 108 connected to it. The connected, in which the arm sections 106, for example, the second arm section 106B is anchored and connected to the upper mount 112, may be applied to induce relatively high force movement of the second arm section 106B and the end effector 108 connected to it.

In order to induce movement of the arm sections 106, specifically movement of the second arm section 106B and its connected end effector 108, the robotic arm 100 may include one or more actuators, for example, one or more first actuators 116 which may be operated to induce movement of the arm section(s) 106 in the disconnected mode and one or more second actuators 118 which may be operated to induce movement of the upper mount 112 and thus movement of the arm section(s) 106 in the connected mode.

For example, an actuator 116A deployed in the shoulder base 104, an actuator 116B deployed at the joint connecting the first arm section 106A and the second arm section 106B, an actuator 116C and/or the like may be instructed and operated, in the disconnected mode, to move one or more of the arm sections 106 to induce movement of the second arm section 106B in the plurality of directions and axes with respect to the plane 102.

The actuators 116A and 116B may be rotational actuators configured to induce rotational movement. For example, since it is deployed in the shoulder base 104, the actuator 116A configured to induce rotational movement may induce rotation movement of the arm sections 106, specifically the second arm section 106B and the end effector 108 around the longitudinal axis (Y axis). In another example, since it is deployed in the joint 110 connecting the first arm section 106A to the second arm section 106B, the actuator 116B configured to induce rotational movement may induce longitudinal movement of the arm sections 106, specifically the second arm section 106B and the end effector 108 in the longitudinal axis (Y axis).

Since the multiple joints 110 connecting the arm sections 106 may enable high precision, accurate, delicate, subtle and very flexible movement of the second arm section 106B, the first actuators 116 may include low-end actuators having standard precision actuators which may be significantly low cost, require reduced maintenance and/or be significantly immune to failures. Moreover, since movement induced in the disconnected mode is low force movement, the first actuators 116 may include relatively small low-cost actuator having limited force.

In another example, an actuator 118A, an actuator 118B and/or the like may be instructed and operated, in the connected mode, to move one or more of the arm sections 106 to induce movement of the second arm section 106B in a plurality of directions and axes with respect to the plane 102. Since in the connected mode, relatively high force movement of the second arm section 106B is required, the actuator(s) 118 may be typically high force actuators capable to induce high force movement of the second arm section 106B, while connected to the upper mount 112, in order to enable the end effector 108 to engage in one or more high force operations.

The actuates 116 and 118 may be operated and/or instructed by one or more controllers, processors and/or other processing devices of the nail polish application apparatus comprising one or more processing units and collectively designate controller.

The nail polish application apparatus may further include storage for storing code (program store), data and/or the like. The storage may include one or more persistent memory devices, for example, a Read Only Memory (ROM) device, a Flash device, a hard drive, an attachable storage media and/or the like as well as one or more volatile devices, for example, a Random Access Memory (RAM), a cache and/or the like.

The controller may execute one or more software modules, for example, a process, an application, an agent, a utility, a tool, a service, an Operating system (OS) and/or the like each comprising a plurality of program instructions executed by the controller from the storage. In particular, the controller may execute one or more software modules, to compute instructions for controlling the robotic arm 100 and instructing the actuator(s) 116 and/or 118 to move the robotic arm 100 accordingly.

For example, in the disconnected mode, the controller may instruct one or more of the first actuators 116, for example, the actuator 116C to induce lateral movement of the second arm section 106B, specifically of the end effector 108 along the Y axis with respect to the plane 102. In another example, the controller may instruct one or more of the actuators 116, for example, the actuator 116B to induce longitudinal movement of the second arm section 106B, specifically of the end effector 108 along the Y axis with respect to the plane 102. In another example, the controller may instruct one or more of the actuators 116, for example, the actuator 116A, 116B and/or 116C to induce perpendicular movement of the second arm section 106B along the Z axis with respect to the plane 102 for lifting the end effector 108. In another example, the controller may instruct one or more of the actuators 116, for example, the actuator 116A to induce rotation movement of the second arm section 106B and the end effector 108 around the longitudinal axis (X axis) with respect to the plane 102.

In another example, in the connected mode, the controller may instruct the actuator(s) 118 to induce movement of the arm sections 106 while anchored and locked to the upper mount 112 such that moving the upper mount 112 may induce movement of the arm sections 106, specifically of the second arm section 106B to which the end effector 108 is connected. For example, the controller may instruct one or more of the second actuator(s) 118, for example, the actuator 118A and/or 118B to induce accurate movement of the second arm section 106B and the end effector 108 in the perpendicular axis with respect to the plane 102 (Z axis) and optionally in the longitudinal axis and/or the lateral axis.

In the context of the nail polish application apparatus, the controller of the nail polish application apparatus may apply the disconnected mode for moving the end effector 108 while grasping the non-screw detachable cover 122. The controller may instruct the first actuator(s) 116 to induce accurate and/or flexible movement of the second arm section 106B in the longitudinal axis, the lateral axis, the perpendicular axis and/or rotation around the longitudinal axis with respect to the plane 102 thus accurately moving the end effector 108 grasping the non-screw detachable cover 122 in order to accurately maneuver the integrated nail polish applying element for accurately and precisely applying nail polish fluid on one or more nail surfaces of the user.

The plurality of joints 110 connecting the arm sections 106 to each other, to the shoulder base 104 and optionally to the end effector 108 may enable highly flexible movement of the second arm section 106B and hence of the end effector 108 grasping the non-screw detachable cover 122 integrating the nail polish applying element. Moreover, the arm sections 106 and the joints 110 may be designed, configured and/or shaped such that when the arm sections 106 are moved, a tip of the dispensing head of the nail polish applying element integrated with the detachable cover 122 grasped by the end effector 108 remains in the same position and/or location in space. The first actuator(s) 116 may be therefore instructed by the controller to alter a movement direction of the dispensing head without changing the current location and/or position of the tip of the dispensing head in space.

This means that the controller may instruct one or more of the first actuators 116, for example, the actuator 116A, the actuator 116B to induce movement of one or more of the arm sections 106, specifically of the second arm section 106B such that the nail polish applying element is rotated in one or more axes with respect to the plane 102 (i.e., X, Y, Z) around the tip of the dispensing head.

Moreover, since the accuracy of the location of the tip of the dispensing head is primarily defined by the construction of the arm sections 106 and the joints 110, the first actuators 116, for example, the actuator 116A and/or the actuator 116B may not be required to support high accuracy which may allow using lower precision and simpler actuators which may reduce their cost.

For example, assuming the controller instructing the first actuator(s) 116 to move the arm section(s) 106 to induce movement of the nail polish applying element in the longitudinal axis with respect to the plane 102 (X axis) in order to maneuver the dispensing head to apply nail polish on a nail surface. Further assuming that the controller detects that the dispensing head reaches a curve in the nail surface. In such case, the controller may instruct the first actuator(s) 116, specifically, the actuator 116A to induce rotation movement, for example, around the longitudinal axis (i.e., around the X axis), to tilt the dispensing head without changing the current location of the tip of the dispensing head which is the initial point for the new movement in the tilted orientation.

In another example, assuming the controller instructing the first actuator(s) 116 to move the arm section(s) 106 to induce movement of the nail polish applying element in the lateral axis with respect to the plane 102 (Y axis) in order to maneuver the dispensing head to apply nail polish on a nail surface. Further assuming that the controller detects that the dispensing head reaches a border of the nail surface. In such case, the controller may instruct the first actuator(s) 116, specifically, the actuator 116B to induce rotation movement, for example, around the perpendicular axis (Z axis) and further instruct the first actuator(s) 116, for example, the actuator 116C to induce lateral movement of the arm section(s) 106 in the opposite direction while the location of the tip pf the dispensing head is not altered and may serve as the starting point for moving in the other direction to apply the nail polish fluid away from the nail surface border.

The controller of the nail polish application apparatus may apply the connected mode to instruct one or more of the second actuators 118 to induce high force movement of the second arm section 106B and hence of the end effector 108 to conduct one or more high force operations. For example, the controller may instruct the second actuator(s) 118, for example, 118A to induce high force movement of the second arm section 106B in an axis perpendicular to the plane 102 (Z axis). Such perpendicular high force movement may be applied to support one or more operations of the end effector which may involve high force, for example, to maneuver the end effector 108 to grasp the non-screw detachable cover 122 of the nail polish capsule 120 integrating the nail polish applying element, detach the detachable cover 122 from the body portion 124 of the nail polish capsule 100 and extract the integrated nail polish applying element out of the body portion 124. In another example, the controller may instruct the second actuator(s) 118, for example, 118A to induce perpendicular high force movement of the second arm section 106B to maneuver the end effector 108 grasping the non-screw detachable cover 122 to insert the integrated nail polish applying element into the body portion 124 and attach the detachable cover 122 to the body portion 124.

However, while typically instructed to induce high force movement of the arm sections 106 in the connected mode, the high force actuators, for example, the second actuator(s) 118 and optionally the actuator 116C may be also instructed and operated by the controller in the disconnected mode. For example, the controller may instruct the second actuator(s) 118 and/or the actuator 116C to induce perpendicular movement of the arm section(s) 106 with respect to the plane 102 (Z axis). In another example, the controller may instruct the second actuator(s) 118 and/or the actuator 116C to induce movement of the arm section(s) 106 in the lateral axis with respect to the plane 102 (Y axis).

Optionally, the actuator 116C may be a high force actuator such as the actuators 118. In such case, while the robotic arm 100 is in the connected mode, the high force actuator 116C may be instructed by the controller, optionally jointly with one or more of the other actuator(s) 118, to induce high force movement of the upper mount 112 and the arm sections 106 for one or more of the high force operations, for example, to receive and hold the capsule 120, to move the capsule 120, to detach/attach the detachable cover 122 from/to the body portion 124, and/or the like. For example, the high force actuator 116C may be instructed by the controller, optionally jointly with one or more of the other actuator(s) 118 to induce high force lateral movement of the upper mount 112 and the arm sections 106 in the X axis with respect to the plane 102. In another example, the high force actuator 116C may be instructed by the controller, optionally jointly with one or more of the other actuator(s) 118, to induce high force perpendicular movement of the upper mount 112 and the arm sections 106 in the Z axis with respect to the plane 102.

In particular, the controller may apply the connected mode to instruct the second actuator(s) 118 to induce high force movement of the upper mount 112 and hence of the second arm section 106B connected (anchored) to the upper mount 112 perpendicularly to the plane 102 to maneuver, specifically lift the end effector 108 to grasp, detach and/or attach the non-screw detachable cover 122 from/to the body portion 124 in the axis perpendicular to the plane 102 while the nail polish capsule 100 is typically located and/or inserted in a capsule compartment and/or chamber adapted to receive and accommodate the nail polish capsule 100. For the high force operations, the second actuator(s) 118 may be therefore selected, configured and/or adapted to induce sufficient force to overcome the detachment (and attachment) force between the non-screw detachable cover 122 and the body portion 124 of the nail polish capsule 120, for example, in a range of 5-15 N (Newton).

In order to support the connected mode and the disconnected mode, the robotic arm 100 may include one or more mechanical anchor provisions, elements and/or connectors 114 to support anchoring and connecting the arm sections 106 to the upper mount 112. One or more of the arm sections 106, specifically the second arm section 106B and the upper mount 112 may be therefore configured and shaped to include anchor provisions and/or elements 114 to support anchoring and connecting the arm sections 106 to the upper mount 112.

In particular, the anchor provisions, elements and/or connectors 114 may be configured to support detachable connection between the arm sections 106 and the upper mount 112 such that the arm sections 106 and the upper mount 112 may be connected and disconnected to and from each other. The controller may therefore instruct one or more of the first actuator(s) 116 to mechanically connect and disconnect between the arm sections 106 and the upper mount 112.

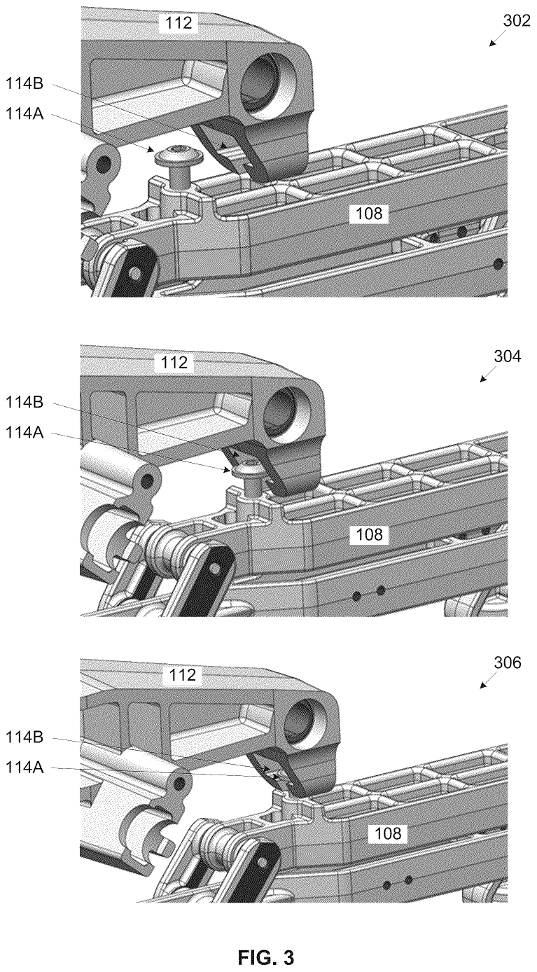

FIG. 3 presents perspective views of exemplary anchor connectors of a robotic arm such as the robotic arm 100 of a nail polish application apparatus in several anchoring states, according to some embodiments of the present invention.

A second arm section such as the second arm section 106B of the robotic arm 100 may be shaped and configured to include a first anchor connector 114A while an upper mount such the upper mount 112 may be shaped and configured to include a second anchor connector 114B.

The first anchor connector 114A and the second anchor connector 114B may be designed, shaped and/or configured to connect to each other using one or more methods, techniques and/or constructions. For example, the first anchor connector 114A disposed on the second arm section 106B may be designed, adapted and/or configured to include a T shaped element and the second anchor connector 114B disposed on the upper mount 112 may be designed, adapted and/or configured to comprise a notch configured to receive and accommodate the T shaped element of the first anchor connector 114A. In another example, the first anchor connector 114A may be designed, adapted and/or configured to include a ball shaped element and the second anchor connector 114B may be designed, adapted and/or configured to comprise a notch configured to receive and accommodate the ball shaped element of the first anchor connector 114A.

Optionally, the first anchor connector 114A may be disposed in the area of the distal end of the second arm section 106B in close proximity to the end effector 108 connected to the distal end of the second arm section 106B in order to reduce the moment and/or force applied on the second arm section 106B in the connected mode.

Moreover, the first anchor connector 114A and the second anchor connector 114B may be configured to connect from one or more directions.

For example, as seen in 302, 304 and 306, the second anchor connector 114B disposed on the upper mount 112 may include a notch having an opening in its rear face such that the first anchor connector 114A, for example, the T shaped element may be inserted into the notch from the rear. In such case, the controller may instruct one or more of the first actuator(s) 116, for example, the actuator 116B to induce a forward movement of the second arm section 106B in the longitudinal axis in order to insert the T shaped element of the first anchor connector 114A disposed on the second arm section 106B into the notch of the second anchor connector 114B disposed on the upper mount 112 and connect them together. Complementary, in such case, the controller may instruct the first actuator(s) 116, for example, the actuator 116B to induce a backward movement of the second arm section 106B in the longitudinal axis in order to remove and disconnect the T shaped element of the first anchor connector 114A from the notch of the second anchor connector 114B.

In another example, assuming the anchor connector 114B disposed on the upper mount 112 includes the notch having an opening in one or both of its side faces to support connection of the first anchor connector 114A, for example, the T shaped element inserted into the notch from the side face(s) of the notch. In such case, the controller may instruct one or more of the first actuator(s) 116, for example, the actuator 116A, to induce a rotation movement of the second arm section 106B around the longitudinal axis in order to insert the T shaped element of the first anchor connector 114A into the notch of the second anchor connector 114B and connect them together. Complementary, in such case, the controller may instruct one or more of the first actuator(s) 116, for example, the actuator 116A, to induce rotation movement of the second arm section 106B in the same or opposite direction compared to the insertion direction in the axis parallel to the plane 102 in order to extract and disconnect the T shaped element of the first anchor connector 114A from the notch of the second anchor connector 114B.

However, in both cases, whether inducing movement of the second arm section 106B in the longitudinal axis or in the lateral axis with respect to the upper mount 112, the controller may instruct one or more of the first actuator(s) 116, for example, the actuator 116A and/or the actuator 116B to induce movement of the second arm section 106B in an axis parallel to the plane 102 to connect between the first anchor connector 114A and the second anchor connector 114B.

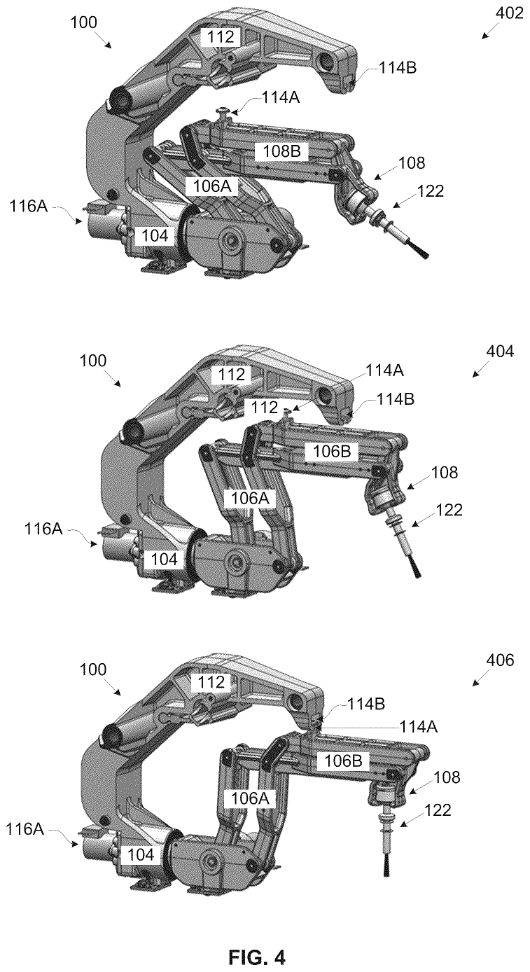

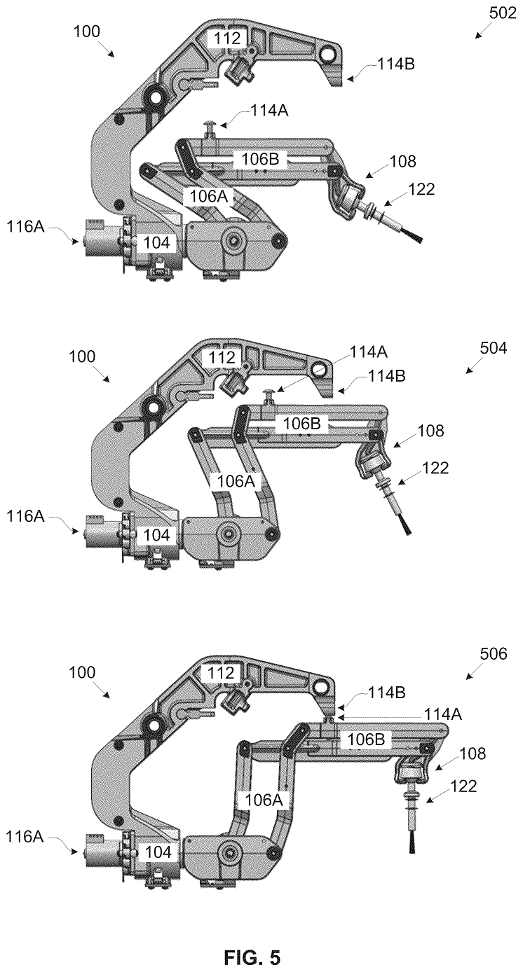

Reference is now made to FIG. 4, which presents perspective views of an exemplary robotic arm such as the robotic arm 100 of a nail polish application apparatus in several anchoring states, according to some embodiments of the present invention. Reference is also made to FIG. 5, which presents corresponding side views of the exemplary robotic arm 100 of a nail polish application apparatus in several anchoring states, according to some embodiments of the present invention.

As seen in perspective views 402, 404, 406 and their corresponding side views 502, 504 and 506, an arm section such as the second arm section 106B of the robotic arm 100 may include a first anchor connector such as the first anchor connector 114A, for example, a T shaped element and an upper mount such as the upper mount 112 of the robotic arm 100 may comprise a second anchor connector 114B, for example, a notch having an opening in its rear face.

As seen in the sequence of views 402, 404, and 406, as well as in 502, 504 and 506, the controller may operate and/or instruct one or more actuators such as the first actuator 116 to induce movement of the second arm section 106, specifically the second arm section 106B to switch from the disconnected mode to the connected mode. The controller may further operate and/or instruct the first actuator(s) 116 in the reverse sequence to switch from the connected mode to the disconnected mode.

As shown at 404 and 504, the controller may further instruct one or more of the first actuator(s) 116, for example, the actuator 116B to induce movement of the second arm section 106B in an axis parallel to a plane such as the plane 102 and optionally in a forward direction in the longitudinal axis to move the first anchor element 114A towards the second anchor element 114B.

As shown at 406 and 506, the controller may instruct one or more of the first actuator(s) 116A, for example, the actuator 116B to further induce movement of the second arm section 106B the axis parallel to the plane 102 to connect between the first anchor element 114A and the second anchor element 114B, specifically in the axis perpendicular to the plane 102.

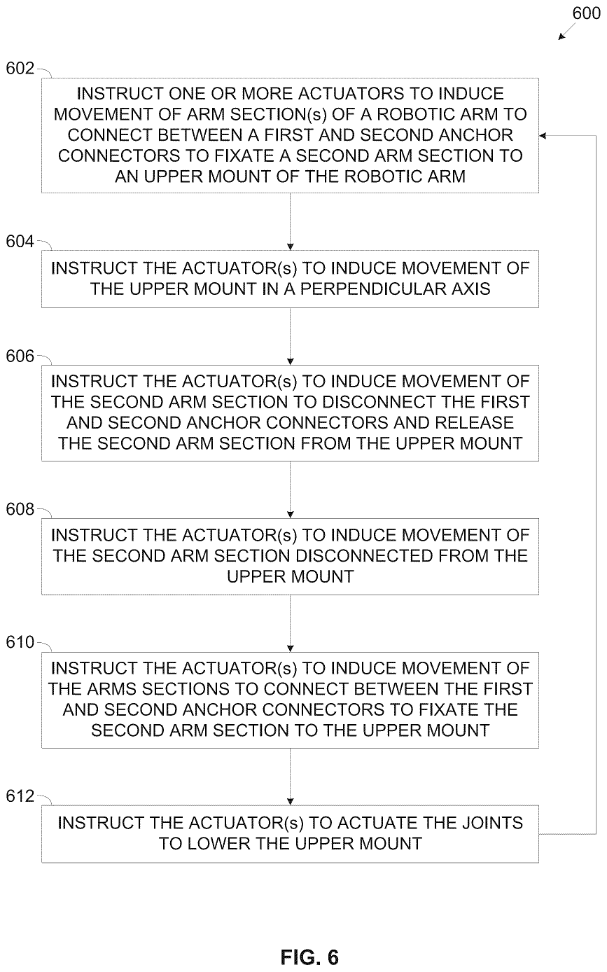

Reference is now made to FIG. 6, which is a flowchart of an exemplary process for operating robotic arm of a nail polish application apparatus to apply, on one or more nail surfaces, nail polish initially contained in a two-part nail polish capsule, according to some embodiments of the present invention.

An exemplary process 600 may be executed by a controller of a nail polish application apparatus to instruct one or more actuators such as the first actuators 116 and/or the second actuators 118 to induce movement of one or more arm segments such as the arm segments 106 of the robotic arm 100.

As shown at 602, the controller may instruct one or more of the first actuators 116, for example, the actuator 116A and/or the actuator 116B to induce movement of a second arm section such as the second arm section 106B to connect between a first anchor connector such as the first anchor connector 114A of the second arm section 106B and a second anchor connector such as the second anchor connector 114B of an upper mount such as the upper mount 112 thus fixating the second arm section 106B to the upper mount 112.

For example, the controller may instruct the actuator 116B to induce movement of the second arm section in the axis parallel to a plane such as the plane 102 in a forward longitudinal axis as described in FIG. 4 and FIG. 5 to connect between the first anchor connector 114A and the second arm section 106B.

Once the first anchor connector 114A of the second arm section 106B are connected, the second arm section 106B is connected and anchored (locked) to the upper mount 112.

As shown at 604, the controller may further instruct one or more of the actuators 118, for example, the actuator 118A to induce high force movement of the upper mount 112 in one or more axes and/or directions with respect to the plane 102. For example, the controller may instruct the actuator 118A to lift the upper mount 112 by inducing movement of the upper mount 112 in the axis perpendicular to the plane 102 (Z axis). In another example, the controller may instruct the actuator 118B to longitudinally move the upper mount 112 with respect to the plane 102 (X axis). In another example, the controller may instruct an actuator 116C to laterally move the upper mount 112 with respect to the plane 102 (Y axis). Since the second arm section 106B is anchored and connected to the upper mount 112, when the upper mount 112 moves, the second arm section 106B and an end effector such as the end effector 108 connected to the second arm section 106B move together with the upper mount 112. For example, inducing perpendicular movement to lift the upper mount 112 may also lift the second arm section 106B and the end effector 108.

Specifically, the controller may instruct one or more of the second actuator(s) 118, for example, the actuator 118A and/or the actuator 118B to move the upper mount 112 to a location above a nail polish capsule such as the nail polish capsule 100 typically located in the capsule compartment or chamber. The controller may then instruct one or more of the second actuator(s) 118, for example, the actuator 118A to lift the upper mount 112 and thus induce movement of the second arm section 106B perpendicularly to the plane 102 for bringing the end effector 108 down to grasp a non-screw detachable cover such as the detachable cover 122 integrating the nail polish applying element typically constructed of a stem protruding from a bottom face of the detachable cover 122 and a dispensing head configured and adapted to collect nail polish from a body portion such as the body portion 124 and apply it to nail surfaces of the user.

The controller may further instruct one or more of the second actuator(s) 118, for example, the actuator 118A to induce high force movement of the upper mount 112 in the axis perpendicular to the plane 102 (Z axis) to lift the upper mount 112 while the end effector 108 grasps the detachable cover 122 in order to detach the detachable cover 122 from the body portion 124.

As shown at 606, the controller may instruct one or more of the first actuators 116, for example, the actuator 116A and/or the actuator 116B to induce movement of the second arm section 106B to disconnect the first anchor connector 114A from the second anchor connector 114B to release the second arm section 106A from the upper mount 112. For example, the controller may instruct the first actuator 116A to induce movement of the second arm section in the axis parallel to the plane 102 in a backward longitudinal axis as described in FIG. 4 and FIG. 5 to disconnect the first anchor connector 114A from the second arm section 106B.

As shown at 608, the controller may instruct one or more of the first actuators 116, for example, the actuator 116A, the actuator 116B and/or the actuator 116C to induce accurate, fine, delicate and/or flexible movement of the second arm section 106B disconnected from the upper mount 112 in the longitudinal axis, the lateral axis, the perpendicular axis and/or rotation around the longitudinal axis with respect to the plane 102. Optionally, in the disconnected mode, the controller may further instruct and/or operate one or more of the actuators 118 to induce movement of the second arm section 106B in one or more axes, for example, in the lateral axes (Y axis) with respect to the plane 102.

In particular, the controller may instruct the first actuator(s) 116 to induce accurate and/or flexible movement of the second arm section 106B thus accurately moving the end effector 108 grasping the non-screw detachable cover 122 in order to accurately maneuver the integrated nail polish applying element for accurately and precisely applying nail polish fluid on the nail surface(s) of the user.

As shown at 610, the controller may instruct the one or more of the first actuators 116, for example, the actuator 116A and/or the actuator 116B to induce movement of the second arm section 106B to connect again between the first anchor connector 114A and the second anchor connector 114B to fixate the second arm section 106B to the upper mount 112.

As shown at 612, once the second arm section 106B is connected to the upper mount 112, the controller may instruct one or more of the second actuators 118, for example, the actuator 118A and/or the actuator 118B to induce one or more high force movements of the upper mount 112 and hence of the second arm section 106B connected to the upper mount 112.

For example, the controller may instruct one or more of the second actuator(s) 118, for example, the actuator 118A, to induce high force movement of the upper mount 112 in the axis perpendicular to the plane 102 (Z axis) to bring down the upper mount 112 while the end effector 108 grasps the detachable cover 122 in order to attach the detachable cover 122 to the body portion 124 for one or more purposes, for example, to dip the dispensing head in the nail polish fluid inside the body portion 124 to collect nail polish fluid, to seal the nail polish capsule 100 and/or the like.

The controller may optionally, repeat the process 600 one or more times. For example, the controller may initiate one or more additional iterations of the process 100 to dip the dispensing head in the nail polish fluid contained in the body portion 124 to collect additional nail polish fluid. In another example, during a pause and/or break in the nail polish application session, the controller may repeat the process 100 to attach the detachable cover 122 to the body portion 124 in order to seal the capsule 100 and prevent evaporation of one or more of its components. In another example, assuming several nail polish capsules such as the nail polish capsule 120 are used during the same nail polish applying session. The plurality of capsules 100 typically inserted and located in dedicated capsule compartments or chambers of the nail polish application apparatus may optionally contain different mail polish fluids, for example, base coat, top coat, polish fluid and/or the like. In such case, the controller may initiate one or more additional iterations of the process 100 to switch and grasp the detachable cover 122 of multiple capsules 100 and attach the detachable covers 122 of the currently unused capsules 100 to seal them.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to ±10 %.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A robotic arm system mounted on a plane, comprising:
at least one actuator adapted to actuate:
a plurality of joints connecting between a shoulder base and a first arm section and between the first arm section and a second arm section having a first anchor connector and connected to an end effector, and
an upper mount connected to the shoulder base for fixating a second anchor connector above the plane; and
a control unit adapted to induce lifting the end effector in relation to the plane by instructing the at least one actuator for:
inducing movement of the second arm section with respect to the upper mount in an axis parallel to the plane to mechanically and detachably connect between the first and second anchor connectors in an axis perpendicular to the plane, and then
lifting the upper mount perpendicularly to the plane.

2. The robotic arm of claim 1, wherein the second anchor connector comprises a notch configured to receive and accommodate a T shaped element of the first anchor connector.

3. The robotic arm of claim 1, wherein the second anchor connector comprises a notch configured to receive and accommodate a ball shaped element of the first anchor connector.

4. The robotic arm of claim 1, wherein the control unit is adapted to instruct the at least one actuator to induce movement of the second arm section in a longitudinal axis parallel to the plane to mechanically and detachably connect between the first and second anchor connectors.

5. The robotic arm of claim 1, wherein the control unit is adapted to instruct the at least one actuator to induce movement of the second arm section in a lateral axis parallel to the plane to mechanically and detachably connect between the first and second anchor connectors.

6. The robotic arm of claim 1, wherein the control unit is adapted to instruct the at least one actuator to induce movement of the second arm section in rotation around a longitudinal axis parallel to the plane to mechanically and detachably connect between the first and second anchor connectors.

7. The robotic arm of claim 1, wherein the control unit is adapted to instruct the at least one actuator to induce movement of the second arm section while the first anchor connector is connected to the second anchor connector to maneuver the end effector to grasp a non-screw detachable cover of a nail polish capsule comprising an integrated nail polish applying element and insert and/or extract the integrated nail polish applying element in and/or out of a body portion of the nail polish capsule.

8. The robotic arm of claim 7, wherein the control unit is further adapted to instruct the at least one actuator to induce movement of the second arm section such that the nail polish applying element rotates in at least one axis with respect to the plane around a tip of a dispensing head of the nail polish applying element.

9. The robotic arm of claim 7, wherein the control unit is adapted to instruct the at least one actuator to induce movement of the second arm section in a longitudinal axis, a lateral axis, and a perpendicular axis with respect to the plane while the first anchor connector is disconnected from the second anchor connector to maneuver the end effector grasping the non-screw detachable cover in order to move the integrated nail polish applying element for applying nail polish fluid on at least one nail surface of a user.

10. The robotic arm of claim 9, wherein the control unit is further adapted to instruct the at least one actuator to induce rotation of the second arm section around the longitudinal axis.

11. A method for operating a robotic arm mounted on a plane, comprising:
using a control unit of a robotic arm adapted to induce lifting of an end effector of the robotic arm with respect to the plane by:
instructing at least one actuator of the robotic arm to actuate a plurality of joints connecting between a shoulder base of the robotic arm and a first arm section of the robotic arm and between the first arm section and a second arm section of the robotic arm having a first anchor connector and connected to the end effector for:
inducing movement of the second arm section with respect to the upper mount in an axis parallel to the plane to mechanically and detachably connect, in an axis perpendicular to the plane, between the first anchor connector and a second anchor connector of the robotic arm fixated by an upper mount connected to the shoulder
lifting the upper mount perpendicularly to the plane.

12. The method of claim 11, wherein the second anchor connector comprises a notch configured to receive and accommodate a T shaped element of the first anchor connector.

13. The method of claim 11, wherein the second anchor connector comprises a notch configured to receive and accommodate a ball shaped element of the first anchor connector.

14. The method of claim 11, further comprising instructing the at least one actuator to induce movement of the second arm section in a longitudinal axis parallel to the plane to mechanically and detachably connect between the first and second anchor connectors.

15. The method of claim 11, further comprising instructing the at least one actuator to induce movement of the second arm section in a lateral axis parallel to the plane to mechanically and detachably connect between the first and second anchor connectors.

16. The method of claim 11, further comprising instructing the at least one actuator to induce movement of the second arm section in rotation around a longitudinal axis parallel to the plane to mechanically and detachably connect between the first and second anchor connectors.

17. The method of claim 11, further comprising instructing the at least one actuator to induce movement of the second arm section while the first anchor connector is connected to the second anchor connector to maneuver the end effector to grasp a non-screw detachable cover of a nail polish capsule comprising an integrated nail polish applying element and insert and/or extract the integrated nail polish applying element in and/or out of a body portion of the nail polish capsule.

18. The method of claim 17, further comprising instructing the at least one actuator to induce movement of the second arm section such that the nail polish applying element rotates in at least one axis with respect to the plane around a tip of a dispensing head of the nail polish applying element.

19. The method of claim 17, further comprising instructing the at least one actuator to induce movement of the second arm section in a longitudinal axis, a lateral axis, and a perpendicular axis with respect to the plane while the first anchor connector is disconnected from the second anchor connector to maneuver the end effector grasping the non-screw detachable cover in order to move the integrated nail polish applying element for applying nail polish fluid on at least one nail surface of a user.

20. The method of claim 11, further comprising instructing the at least one actuator to induce rotation of the second arm section around the longitudinal axis.
